(19) United States
(12) Patent Application Publication
(10) Pub. No.: US 2025/0105706 A1
(43) Pub. Date: Mar. 27, 2025

(54) ELECTRIC COMPRESSOR

(71) Applicant: HYUNDAI WIA Corporation, Gyeongsangnam-do (KR)

(72) Inventors: Yong Min SHIN, Gyeonggi-do (KR); Tae Hwan KIM, Gyeonggi-do (KR); Myung Jin KIM, Gyeonggi-do (KR)

(21) Appl. No.: 18/385,787

(22) Filed: Oct. 31, 2023

(30) Foreign Application Priority Data
Sep. 25, 2023 (KR) 10-2023-0128561

(51) Int. Cl. H02K 11/00; H02K 5/22; H02K 11/20

(52) U.S. Cl. CPC H02K 11/0094; H02K 5/22; H02K 11/20; H02K 2211/03

(57) ABSTRACT

An electric compressor including an inverter housing in which an inverter component for controlling a motor is embedded, the inverter housing having a through-hole formed in one side surface thereof, an electronic component installed in the inverter housing and having one end protruding and exposed toward the motor through the through-hole. A motor housing is coupled to the inverter housing and includes an internal space in which the motor is embedded. An accommodation space is provided in an outer portion of a lateral portion of the motor housing and separated from the internal space, and an exposed portion of the electronic component is inserted into the accommodation space.

### CROSS REFERENCE TO RELATED APPLICATION

The present application claims priority of Korean Patent Application No. 10-2022-0154887, filed on Nov. 17, 2022, and Korean Patent Application No. 10-2023-0128561, filed on Sep. 25, 2023, the entire contents of which is incorporated herein for all purposes by this reference.

### BACKGROUND

### Field

The present disclosure relates to an electric compressor including a motor housing having a space into which a protruding electronic component of an inverter housing is inserted when the motor housing and the inverter housing are coupled.

### Description of the Related Art

In general, an air conditioning (A/C) device is installed in a vehicle to cool or heat the interior of the vehicle. The air conditioning device includes a compressor which is a component of a cooling system, and the compressor compresses a low-temperature and low-pressure gaseous refrigerant introduced from an evaporator to make a high-temperature and high-pressure gaseous refrigerant and delivers the refrigerant to a condenser.

Further, the compressor applied to the vehicle is typically configured as a mechanical compressor configured to operate by receiving driving power of an engine or an electric compressor configured to operate by receiving driving power of a motor.

Meanwhile, the compressors are classified into a reciprocating compressor which compresses a refrigerant using a reciprocating motion of a piston, and a rotary compressor which compresses a refrigerant using a rotational motion. The rotary compressors are classified into a vane rotary compressor using a rotating rotary shaft and a vane and a scroll compressor using an orbiting scroll and a fixed scroll.

The scroll compressor has an advantage in that the scroll compressor may obtain a relatively higher compression ratio than other compressors, smoothly perform processes of introducing, compressing, and discharging the refrigerant, and thus obtain stable torque. Therefore, the scroll compressor is widely used to compress the refrigerant in an air conditioning device or the like.

In the case of the scroll compressor in the related art, a holder for fixing and protecting electronic components is provided on an inverter housing including the electronic components, such that a position of the holder provided on the inverter housing is taken into consideration at the time of coupling the inverter housing to a motor housing including a motor. For this reason, a space is defined between the motor housing and the holder, and we have found that the defined space may cause a problem in that a packaging size of the compressor increases in a direction of a rotation radius of the motor.

In addition, the inverter housing dissipates heat by transferring heat, which is generated in the inverter housing, to the motor housing. However, because the electronic component is provided to be spaced apart from the motor housing, we have found that a transfer route for the heat generated by the electronic component is lengthened, which may cause a problem of deterioration in heat dissipation performance of the inverter housing.

Further, a size of a package of the compressor may be restricted, and the electronic component may be positioned while defining a space together with a lateral portion of the motor housing, such that a connector connected in a direction parallel to the electronic component may be disposed and positioned forward of the electronic component because of the size restriction. In case that the connector is disposed and positioned forward of the electronic component as described above, the connector is connected to the inverter housing by wiring, and a wire harness is further provided, which we have found causes a problem in that the connection between the connector and the inverter housing is complicated.

The foregoing explained as the background is intended merely to aid in the understanding of the background of the present disclosure, and is not intended to mean that the present disclosure falls within the purview of the related art that is already known to those skilled in the art.

### SUMMARY

The present disclosure is proposed to solve these problems and aims to provide an electric compressor including a motor housing having a space into which a protruding electronic component of an inverter housing is inserted when the motor housing and the inverter housing are coupled.

Technical problems to be solved by the present disclosure are not limited to the above-mentioned technical problems, and other technical problems, which are not mentioned above, may be clearly understood from the following descriptions by those skilled in the art to which the present disclosure pertains.

In order to achieve the above-mentioned object, the present disclosure provides an electric compressor including: an inverter housing in which an inverter component for controlling a motor is embedded, the inverter housing having a through-hole formed in one side surface thereof; an electronic component installed in the inverter housing and having one end protruding and exposed toward the motor through the through-hole; and a motor housing coupled to the inverter housing and including an internal space in which the motor is embedded, and an accommodation space provided in an outer portion of a lateral portion of the motor housing and separated from the internal space, and an exposed portion of the electronic component being inserted into the accommodation space.

For example, the inverter housing may include a front cover and a rear cover, and the through-hole may be formed in the front cover positioned adjacent to the motor.

For example, the accommodation space of the motor housing may be opened at one end thereof, and the exposed portion of the electronic component may be inserted into the accommodation space through the opened end.

For example, the motor housing may have a coupling surface coupled to the inverter housing, and the accommodation space of the motor housing may be disposed on the same plane as the coupling surface and opened toward the inverter housing.

For example, a rear end surface of the motor housing and a rear end surface of the accommodation space may be coupled to a front end surface of the inverter housing, and a gasket may be provided between the coupled rear end surface of the motor housing, the coupled rear end surface of the accommodation space, and the coupled front end surface of the inverter housing.

For example, the gasket may be formed along outer peripheral lines of the rear end surface of the motor housing and the rear end surface of the accommodation space coupled to the front end surface of the inverter housing.

For example, the electric compressor may further include: a printed circuit board on which a switching element and the electronic component are installed, in which the printed circuit board is embedded in the inverter housing.

For example, the electric compressor may further include: a connector positioned outside a lateral portion of the accommodation space of the motor housing, in which the connector is coupled to the inverter housing.

For example, the inverter housing may further extend upward from a side at which the electronic component is positioned, and the connector may be coupled to an extending portion of the inverter housing.

For example, the connector may penetrate the inverter housing and be fastened directly to a printed circuit board by means of a connection pin in the inverter housing.

For example, the connector, the electronic component, and the motor may be disposed to overlap one another in an upward/downward direction.

For example, the internal space and the accommodation space of the motor housing may be separated by a single partition wall.

For example, the accommodation space may include a first accommodation space and a second accommodation space, and different types of electronic components may be respectively inserted into the first accommodation space and the second accommodation space.

For example, the first accommodation space may be formed in the outer portion of the lateral portion of the motor housing and separated from the internal space, and the second accommodation space may extend outward from a lateral portion of the first accommodation space.

For example, the second accommodation space may extend outward from one side of a lateral portion of the first accommodation space, and a protruding space may be formed in the inverter housing and protrude to be disposed at a lateral side of the second accommodation space.

For example, the second accommodation space and the protruding space may be disposed adjacent to an outer side of the lateral portion of the first accommodation space.

For example, the electric compressor may further include: a connector fastened to the protruding space of the inverter housing.

For example, the connector may be electrically connected to a printed circuit board in the inverter housing.

For example, the internal space and the accommodation space of the motor housing may be spaces separated from each other and integrally formed together.

According to the electric compressor according to the present disclosure, the accommodation space into which the electronic component is inserted is formed in the motor housing, such that a space defined between the electronic component and the motor housing is eliminated. Therefore, it is possible to reduce the size of the package of the compressor, shorten the thermal conduction route of the electronic component, improve the heat dissipation performance, and simplify the connection structure of the connector connected to the inverter housing.

The effects capable of being obtained by the present disclosure are not limited to the aforementioned effects, and other effects, which are not mentioned above, will be clearly understood by those skilled in the art from the following description.

### BRIEF DESCRIPTION OF THE DRAWINGS

FIG. 1 is a cross-sectional view of an electric compressor according to an embodiment of the present disclosure.

FIG. 2 is an exploded perspective view of the electric compressor according to the embodiment of the present disclosure.

FIG. 3 is a perspective view of a printed circuit board included in the electric compressor according to the embodiment of the present disclosure.

FIGS. 4 to 6 are views illustrating an electric compressor according to another embodiment of the present disclosure.

### DETAILED DESCRIPTION

In the description of the embodiments disclosed in the present specification, the specific descriptions of publicly known related technologies will be omitted when it is determined that the specific descriptions may obscure the subject matter of the embodiments disclosed in the present specification. In addition, it should be interpreted that the accompanying drawings are provided only to allow those skilled in the art to easily understand the embodiments disclosed in the present specification, and the technical spirit disclosed in the present specification is not limited by the accompanying drawings, and includes all alterations, equivalents, and alternatives that are included in the spirit and the technical scope of the present disclosure.

The terms including ordinal numbers such as “first,” “second,” and the like may be used to describe various constituent elements, but the constituent elements are not limited by the terms. These terms are used only to distinguish one constituent element from another constituent element.

When one constituent element is described as being “coupled” or “connected” to another constituent element, it should be understood that one constituent element can be coupled or connected directly to another constituent element, and an intervening constituent element can also be present between the constituent elements. When one constituent element is described as being “coupled directly to” or “connected directly to” another constituent element, it should be understood that no intervening constituent element is present between the constituent elements.

Singular expressions include plural expressions unless clearly described as different meanings in the context.

In the present specification, it should be understood the terms “comprises,” “comprising,” “includes,” “including,” “containing,” “has,” “having” or other variations thereof are inclusive and therefore specify the presence of stated features, integers, steps, operations, elements, components, or combinations thereof, but do not preclude the presence or addition of one or more other features, integers, steps, operations, elements, components, or combinations thereof.

Hereinafter, embodiments disclosed in the present specification will be described in detail with reference to the accompanying drawings. The same or similar constituent elements are assigned with the same reference numerals regardless of reference numerals, and the repetitive description thereof will be omitted.

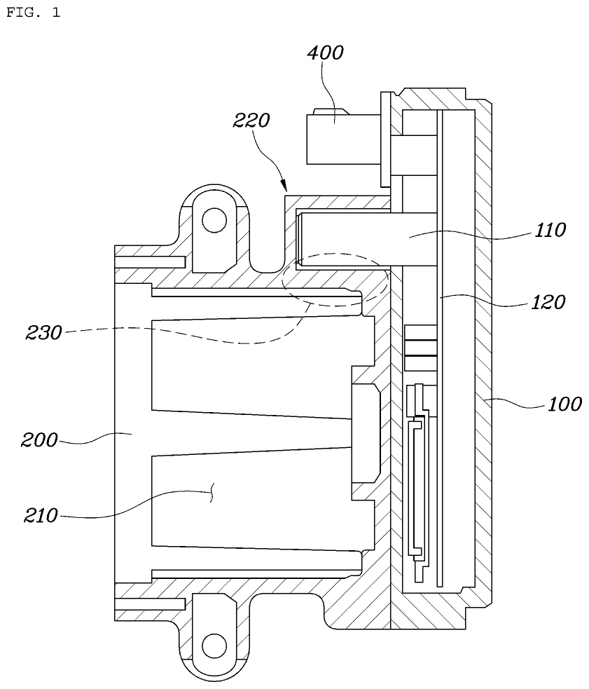

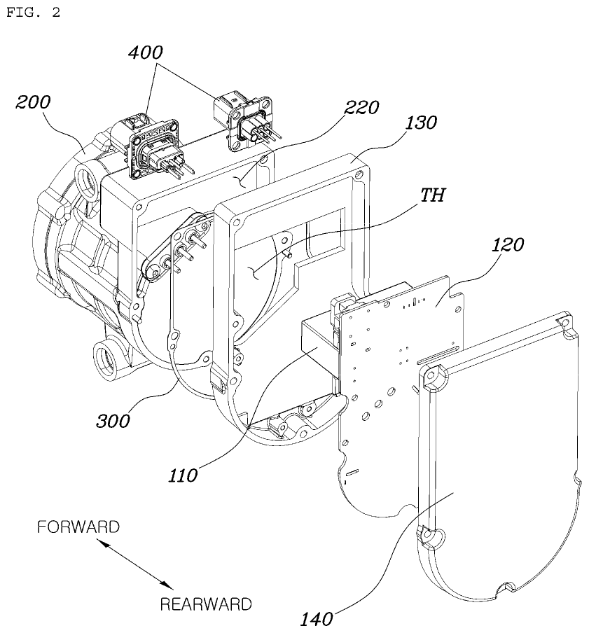

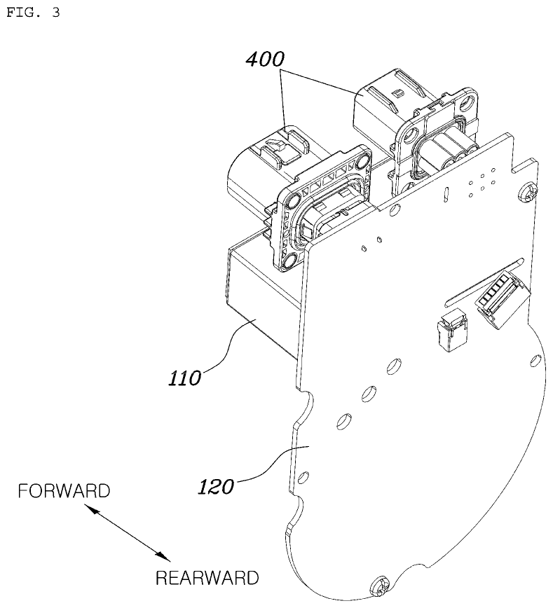

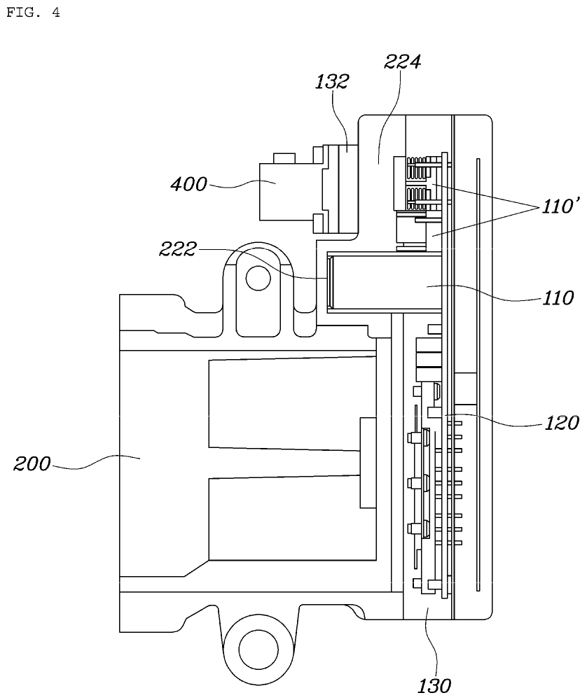

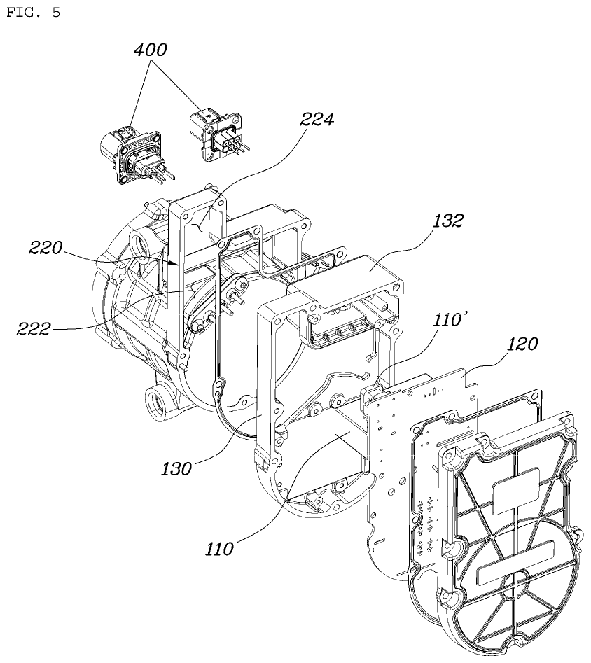

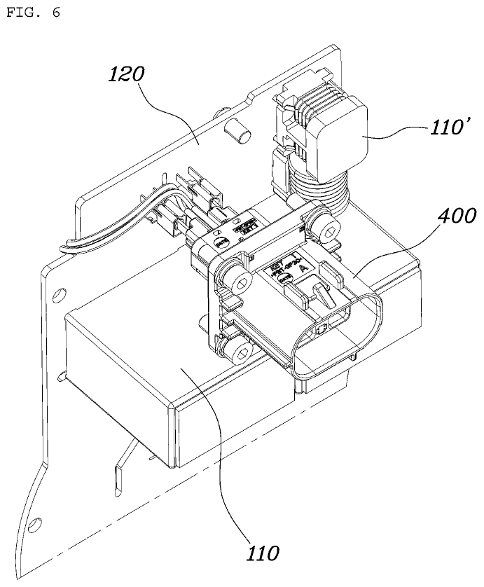

FIG. 1 is a cross-sectional view of an electric compressor according to an embodiment of the present disclosure, FIG. 2 is an exploded perspective view of the electric compressor according to the embodiment of the present disclosure, FIG. 3 is a perspective view of a printed circuit board included in the electric compressor according to the embodiment of the present disclosure, and FIGS. 4 to 6 are views illustrating an electric compressor according to another embodiment of the present disclosure.

A configuration of an electric compressor according to an embodiment of the present disclosure will be described with reference to FIG. 1.

FIG. 1 is a cross-sectional view of an electric compressor according to an embodiment of the present disclosure.

With reference to FIG. 1, an electric compressor according to an embodiment of the present disclosure may include an inverter housing 100 and a motor housing 200. An inverter component configured to control a motor may be embedded in the inverter housing 100. The inverter component may be installed in the inverter housing 100 and include an electronic component 110 having one end protruding and exposed toward the motor. For example, the electronic component according to the embodiment of the present disclosure may mean a capacitor.

In addition, the inverter component may include a switching element (not illustrated) configured to control three phases (e.g., a U phase, a V phase, and a W phase) of the motor. The inverter components including the electronic component 110 and the switching element may be installed on a printed circuit board 120. The printed circuit board 120 on which the inverter component is installed may be embedded in the inverter housing 100.

The motor housing 200 is coupled to the inverter housing 100 and has an internal space 210 in which the motor is embedded. An accommodation space 220 may be formed in an outer portion of a lateral portion of the motor housing 200 and separated from the internal space 210. Further, when the motor housing 200 and the inverter housing 100 are coupled, an exposed portion of the electronic component 110 may be inserted into the accommodation space 220 of the motor housing 200. That is, when the inverter housing 100 and the motor housing 200 are coupled, the accommodation space 220 may accommodate the electronic component 110 exposed from the inverter housing 100 and block and protect the electronic component 110 from the outside. In addition, when the accommodation space 220 is formed to correspond to a size of the electronic component 110, the electronic component 110 may be fixed by the accommodation space 220 when the inverter housing 100 and the motor housing 200 are coupled, such that a coupling force between the inverter housing 100 and the motor housing 200 may increase.

As described above, the motor housing 200 according to the embodiment of the present disclosure has the accommodation space 220 into which the electronic component 110 is inserted, such that a thermal conduction route of the electronic component 110 may be shortened.

In the related art, the internal space 210 is formed in the motor housing 200, and the accommodation space 220, into which the electronic component 110 is inserted, is formed in the inverter housing 100, such that the inverter housing 100 and the motor housing 200 may be coupled in consideration of a position of the accommodation space 220 formed in the inverter housing 100. Therefore, a plurality of partition walls, which is separated from one another, may exist between the motor housing 200 and the accommodation space 220, and spaces may be defined.

A partition wall 230 provided between the internal space 210 and the accommodation space 220 may affect the thermal conduction route of the inverter component including the electronic component 110 embedded in the inverter housing 100, which may cause a difference in heat dissipation performance. For example, in the case of the inverter components including the electronic component 110 embedded in the inverter housing 100, heat is generated when the motor operates. Therefore, it is necessary to dissipate heat in order to prevent the malfunction of the inverter component. The heat generated from the inverter housing 100 may be dissipated mainly through the motor housing 200. A thermal conduction pad (not illustrated) may be provided on the inverter housing 100 to dissipate heat by transferring the heat to the motor housing 200. The thermal conduction pad may easily transfer the heat, which is generated by the inverter component embedded in the inverter housing 100, to the motor housing 200.

In one embodiment, because the electronic component 110 is positioned in the accommodation space 220, the heat is conducted through the thermal conduction pad provided in the accommodation space 220, the heat conducted to the thermal conduction pad is conducted back to the thermal conduction pad provided along the inverter housing 100, and the heat may be conducted to the motor housing 200 through the thermal conduction pad provided on the inverter housing 100. That is, when the accommodation space 220 is provided in the inverter housing 100, the thermal conduction route for the heat generated by the electronic component 110 may be formed in a direction from the accommodation space 220 toward the inverter housing 100 and a direction from the inverter housing 100 toward the motor housing 200.

According to the embodiment of the present disclosure, the motor housing 200 has the accommodation space 220 into which the electronic component 110 is inserted, such that the internal space 210 and the accommodation space 220 of the motor housing 200 may be separated by the single partition wall 230. The accommodation space 220 is formed in the motor housing 200, and the electronic component 110 is inserted into the accommodation space 220, such that the heat generated by the electronic component 110 may be conducted to the thermal conduction pad provided in the accommodation space 220, and the heat conducted to the thermal conduction pad may be transferred to the motor housing 200 through the partition wall 230. Therefore, because the accommodation space 220 is formed in the motor housing 200, the thermal conduction route of the heat generated by the electronic component 110 is formed in the direction from the accommodation space 220 to the motor housing 200 direction, such that the thermal conduction route may be shortened in comparison with the structure in the related art.

The thermal conduction route of the electronic component 110 may be an indicator for measuring heat dissipation performance of the electronic component 110. Because the accommodation space 220 according to the embodiment of the present disclosure is formed in the motor housing 200, the thermal conduction route of the electronic component 110 may be shortened, which directly affects heat dissipation performance of the electronic component 110, thereby improving the heat dissipation performance of the electronic component 110.

In addition, because the accommodation space 220 is formed in the motor housing 200, the single partition wall 230 may be formed between the internal space 210 and the accommodation space 220 of the motor housing 200. Therefore, a packaging size of the electric compressor, which is manufactured by coupling the motor housing 200 and the inverter housing 100, may decrease in an upward/downward direction.

Hereinafter, the electric compressor according to the embodiment of the present disclosure will be specifically described with reference to FIG. 2.

FIG. 2 is an exploded perspective view of the electric compressor according to the embodiment of the present disclosure.

With reference to FIG. 2, the electronic component 110 may have the largest volume among the inverter components. A through-hole TH may be formed in the inverter housing 100 as one end of the electronic component 110 protrudes toward the motor and is exposed in the inverter housing 100. In particular, the inverter housing 100 includes a front cover 130 and a rear cover 140, such that the through-hole TH may be formed in the front cover 130 positioned adjacent to the motor.

The electronic component 110, which is exposed toward the motor through the through-hole TH, may be inserted into the accommodation space 220 formed in the motor housing 200. Therefore, the accommodation space 220 is opened at one end thereof, and a portion of the electronic component 110, which is exposed through the opened end, may be inserted into the accommodation space 220. According to the embodiment of the present disclosure, as the inverter housing 100 and the motor housing 200 are coupled, the motor housing 200 may have a coupling surface (e.g., a rear end surface of the motor housing) to which the inverter housing 100 is coupled. The accommodation space 220 may be provided on the same plane as the formed coupling surface and opened toward the inverter housing 100. That is, the opened end of the accommodation space 220 may be formed in the rear end surface, such that the accommodation space 220 may be opened rearward. However, this configuration is provided for illustrative purposes only, and of course one opened end of the accommodation space 220 is not limited to the above-mentioned position.

In addition, when the inverter housing 100 and the motor housing 200 are coupled, a rear end surface of the motor housing 200 and a rear end surface of the accommodation space 220 may be coupled to a front end surface of the inverter housing 100. Further, a gasket 300 may be provided between the rear end surface of the motor housing 200, the rear end surface of the accommodation space 220, and the front end surface of the inverter housing 100. The gasket 300 may be provided between surfaces coupled for packing when the inverter housing 100 and the motor housing 200 are coupled. Further, because the accommodation space 220 is formed in the motor housing 200, the coupling surface of the motor housing 200, which is coupled to the inverter housing 100, may be enlarged, and the gasket 300 may be deformed in shape to maintain packing between the inverter housing 100 and the motor housing 200. As illustrated in FIG. 2, the shape of the gasket 300 may be formed along outer peripheral lines of the rear end surface of the motor housing 200 and the rear end surface of the accommodation space 220 coupled to the front end surface of the inverter housing 100.

Further, the electric compressor according to the embodiment of the present disclosure may further include connectors 400. A single connector 400 or a plurality of connectors 400 may be provided in some instances. In the embodiment of the present disclosure, it is assumed that the plurality of connectors 400 exists. In case that the plurality of connectors 400 exists, the connectors 400 may include a high-voltage connector connected to a high-voltage terminal, and a low-voltage connector connected to a low-voltage terminal. However, this configuration is provided for illustrative purposes only, and of course the connector 400 is not limited to the above-mentioned configuration.

Further, the connectors 400 may be positioned outside the lateral portion of the accommodation space 220 of the motor housing 200. With reference to the cross-sectional view illustrated in FIG. 1, the connectors 400 are positioned outside the lateral portion of the accommodation space 220, such that the connectors 400, the electronic component 110, and the motor may be disposed to overlap one another in the upward/downward direction. The connector 400 is disposed to overlap the electronic component 110 in the upward/downward direction, such that the package size of the electric compressor may decrease in the upward/downward direction.

In addition, the connector 400 may be positioned outside the lateral portion of the accommodation space 220 and coupled to the inverter housing 100. For example, the inverter housing 100 may further extend upward from a side at which the electronic component 110 is positioned. The connector 400 may be coupled to an extending portion of the inverter housing 100. In particular, the connector 400 may penetrate the inverter housing 100 and fastened directly to the printed circuit board 120 by means of a connection pin provided at an end of the connector 400 in the inverter housing 100. This configuration will be described with reference to FIG. 3.

FIG. 3 is a perspective view of the printed circuit board included in the electric compressor according to the embodiment of the present disclosure.

With reference to FIG. 3, the connector 400 may be connected directly to the printed circuit board 120 without wiring. In case that the accommodation space 220 is formed in the inverter housing 100 and the connector 400 is disposed outside the lateral portion of the accommodation space 220, there may occur a problem in that the packaging size of the electric compressor increases. Therefore, in case that the accommodation space 220 is formed in the inverter housing 100, the connector 400 is disposed forward of the accommodation space 220, and the end of the connector 400 is connected, by wiring, to the printed circuit board 120 embedded in the inverter housing 100. Therefore, it is possible to prevent an increase in packaging size of the electric compressor.

In case that separate wiring is applied to connect the connector 400 and the printed circuit board 120, a wiring harness (not illustrated) for supporting the wiring may be provided. However, the wiring and the wiring harness may cause a problem in that the connection between the connector 400 and the printed circuit board 120 is complicated.

Therefore, according to the electric compressor according to the embodiment of the present disclosure, the accommodation space 220 is formed in the motor housing 200, and the single partition wall 230 is provided between the internal space 210 and the accommodation space 220, such that the electronic component 110 and the connector 400 may be disposed to overlap each other in the upward/downward direction. In addition, therefore, it is possible to simplify the connection between the connector 400 and the printed circuit board 120. That is, the connector 400 may be fastened directly to the printed circuit board 120, which is embedded in the inverter housing 100, without wiring.

FIGS. 4 to 6 are views illustrating an electric compressor according to another embodiment of the present disclosure.

According to another embodiment of the present disclosure, the accommodation space 220 is divided into a first accommodation space 222 and a second accommodation space 224, and different types of electronic components may be respectively inserted into the spaces.

Specifically, the first accommodation space 222 may be formed at an upper side of the motor, the second accommodation space 224 may be formed at one side of an upper side of the first accommodation space 222, and a protruding space 132 may be disposed at the other side of the upper side of the first accommodation space 222 and protrude from the inverter housing 130. Further, the connector 400 may be fastened to the protruding space 132. As described above, the connector 400 is electrically connected to the printed circuit board 120 in the inverter housing 130.

The first accommodation space 222 and the second accommodation space 224 may be spaces connected to each other and may be formed into the single motor housing by a casting process method or the like while being integrated with the internal space 210 in which the motor is installed.

A capacitor 110, as the electronic component, may be installed in the first accommodation space 222, and high-voltage filters 110′ and the like, as the electronic components, may be installed in the second accommodation space 224. Further, the heat of the installed components may be dissipated through the motor housing. According to the positions, the first accommodation space 222 is formed at the upper side of the motor, the second accommodation space 224 is formed at one side of the upper side of the first accommodation space 222, and the protruding space 132 and the connector 400 are disposed at the other side of the upper side of the first accommodation space 222, such that plurality of electronic components 110 and 110′ may be cooled, and the overall arrangement of the components may be optimized, and the size of the module may be reduced.

According to the electric compressor according to the embodiment of the present disclosure, the accommodation space into which the electronic component is inserted is formed in the motor housing, such that a space defined between the electronic component and the motor housing is eliminated. Therefore, it is possible to reduce the size of the package of the compressor, shorten the thermal conduction route of the electronic component, improve the heat dissipation performance, and simplify the connection structure of the connector connected to the inverter housing.

While the specific embodiments of the present disclosure have been illustrated and described, it will be obvious to those skilled in the art that the present disclosure may be variously modified and changed without departing from the technical spirit of the present disclosure defined in the appended claims.

The present disclosure described above may be implemented as a computer-readable code on a medium on which a program is recorded. The computer-readable medium includes all kinds of storage devices for storing data readable by a computer system. Examples of computer-readable media include hard disk drives (HDDs), solid state disks (SSDs), silicon disk drives (SDDs), ROMs, RAMs, CD-ROMs, magnetic tapes, floppy discs, and optical data storage devices. Therefore, it should be appreciated that the detailed description is interpreted as being illustrative in every aspects, not restrictive. The scope of the present disclosure should be determined based on the reasonable interpretation of the appended claims, and all of the modifications within the equivalent scope of the present disclosure belong to the scope of the present disclosure.

DESCRIPTION OF REFERENCE NUMERALS

| | |
|---|---|
| 100: Inverter housing | 110: Electronic component |
| 120: Printed circuit board | 130: Front cover |
| 140: Rear cover | 200: Motor housing |
| 210: Internal space | 220: Accommodation space |
| 230: Partition wall | 300: Gasket |
| 400: Connector | TH: Through-hole |

What is claimed is:

1. An electric compressor comprising:
an inverter housing in which an inverter component for controlling a motor is embedded, the inverter housing having a through-hole formed in one side surface thereof; an electronic component installed in the inverter housing and having an exposed portion including one end protruding and exposed toward the motor through the through-hole; and
a motor housing coupled to the inverter housing and including an internal space in which the motor is embedded, an accommodation space provided in an outer portion of a lateral portion of the motor housing and separated from the internal space, and the exposed portion of the electronic component being inserted into the accommodation space.

2. The electric compressor of claim 1, wherein the inverter housing comprises a front cover and a rear cover, and the through-hole is formed in the front cover and positioned adjacent to the motor.

3. The electric compressor of claim 1, wherein the accommodation space of the motor housing is open at one end thereof, and the exposed portion of the electronic component is inserted into the accommodation space through the open end.

4. The electric compressor of claim 3, wherein the motor housing has a coupling surface coupled to the inverter housing, and the accommodation space of the motor housing is disposed on the same plane as the coupling surface and opened toward the inverter housing.

5. The electric compressor of claim 1, wherein a rear end surface of the motor housing and a rear end surface of the accommodation space are coupled to a front end surface of the inverter housing, and a gasket is provided between the coupled rear end surface of the motor housing, the coupled rear end surface of the accommodation space, and the coupled front end surface of the inverter housing.

6. The electric compressor of claim 5, wherein the gasket is formed along outer peripheral lines of the rear end surface of the motor housing and the rear end surface of the accommodation space coupled to the front end surface of the inverter housing.

7. The electric compressor of claim 1, further comprising:
a printed circuit board on which a switching element and the electronic component are installed, wherein the printed circuit board is embedded in the inverter housing.

8. The electric compressor of claim 1, further comprising:
a connector positioned outside a lateral portion of the accommodation space of the motor housing, wherein the connector is coupled to the inverter housing.

9. The electric compressor of claim 8, wherein the inverter housing further extends upward from a side at which the electronic component is positioned, and the connector is coupled to an extending portion of the inverter housing.

10. The electric compressor of claim 8, wherein the connector penetrates the inverter housing and is fastened directly to a printed circuit board by means of a connection pin in the inverter housing.

11. The electric compressor of claim 8, wherein the connector, the electronic component, and the motor are disposed to overlap one another in an upward/downward direction.

12. The electric compressor of claim 1, wherein the internal space and the accommodation space of the motor housing are separated by a single partition wall.

13. The electric compressor of claim 1, wherein the accommodation space comprises a first accommodation space and a second accommodation space, and different types of electronic components are respectively inserted into the first accommodation space and the second accommodation space.

14. The electric compressor of claim 13, wherein the first accommodation space is formed in the outer portion of the lateral portion of the motor housing and separated from the internal space, and the second accommodation space extends outward from a lateral portion of the first accommodation space.

15. The electric compressor of claim 13, wherein the second accommodation space extends outward from one side of a lateral portion of the first accommodation space, and a protruding space is formed in the inverter housing and protrudes to be disposed at a lateral side of the second accommodation space.

16. The electric compressor of claim 15, wherein the second accommodation space and the protruding space are disposed adjacent to an outer side of the lateral portion of the first accommodation space.

17. The electric compressor of claim 15, further comprising a connector fastened to the protruding space of the inverter housing.

18. The electric compressor of claim 17, wherein the connector is electrically connected to a printed circuit board in the inverter housing.

19. The electric compressor of claim 1, wherein the internal space and the accommodation space of the motor housing are separated from each other and integrally formed within the motor housing.
